(19) United States
(12) Patent Application Publication
(10) Pub. No.: US 2017/0286981 A1
(43) Pub. Date: Oct. 5, 2017

(54) System And Method For Analyzing Geopolitical Attributes Over Time Via A Digital Computer

(71) Applicant: FTI Consulting, Inc., Annapolis, MD (US)

(72) Inventors: Arun Shukla, Raleigh, NC (US); Andrew Klemm, Marietta, GA (US)

(21) Appl. No.: 15/090,894

(22) Filed: Apr. 5, 2016

(51) Int. Cl. G06Q 30/02; G06Q 10/06

(52) U.S. Cl. CPC G06Q 30/0205; G06Q 10/0635; G06Q 30/0201

(57) ABSTRACT

A system and method for analyzing geopolitical attributes over time via a digital computer is provided. Markets of interest are identified. Qualitative data regarding one or more attributes is received for each of the markets of interest at predefined time periods. A score is determined for each market based on the qualitative data for that market. The score for each market is then classified as having a location desirability value. The scores and the location desirability values are displayed for each of the markets at each of the predetermined times.

### FIELD

The invention relates in general to data analysis and, specifically, to a system and method for analyzing geopolitical attributes over time via a digital computer.

### BACKGROUND

As companies grow and become successful, expansion into different markets is frequently considered. A decision to expand is generally well thought out and researched extensively due to the high costs and risk associated with expansion. The research can be focused on factors, such as location, taxes, labor laws, consuming public, and risk, for each market in consideration. Results of the research are then used to make a determination for or against expansion.

For example, once the appropriate research has been conducted, the results are provided to one or more decision makers to consider whether expansion is beneficial. If yes, plans to expand are usually generated and executed. Thus, a company looking to expand into an emerging market generally makes the decision to expand based on a point-in-time consideration of market risk based on the research results without considering any further changes in the market over time.

However, expanding to a new market is time-consuming and can take months or years before business in the expansion market is fully operational. From the time the research results are provided for a particular market to the time the expansion is completed, risk of expansion within the market can change dramatically. Determining risk over a single period of time without further analyzing risk level changes can lead companies to relying on the risk analysis over a particular period of time when, in contrast, the level of risk can be constantly changing. If the risk level changes drastically enough, expansion may no longer be beneficial for the company or performance of an already established expansion market may decrease.

Currently, risk can be calculated using the Zurich International risk model, which measures risk over a single predefined period of time. A decision for expansion is then made based on a measure of risk for the corresponding period of time. Thus, the model fails to provide continuous updates to the risk measure to ensure a decision to expand remains beneficial or to utilize the calculated risk to assist established companies in adjusting work performance based on the calculated risk for a particular market.

Thus, there remains a need for continuously and accurately evaluating risk in different markets, as well as maintaining and improving market performance based on the risk evaluations, to ensure that expected returns justify the risk. Preferably, the risk evaluation provides a measure of how the risk changes over a periods of time for a market.

### SUMMARY

An embodiment provides a computer-implemented system and method for analyzing geopolitical attributes over time via a digital computer is provided. Markets of interest are identified. Qualitative data regarding one or more attributes is received for each of the markets of interest at predefined time periods. A score is determined for each market based on the qualitative data for that market. The score for each market is then classified as having a location desirability value. The scores and the location desirability values are displayed for each of the markets at each of the predetermined times.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a functional block diagram showing a system for analyzing geopolitical attributes over time via a digital computer, in accordance with one embodiment.

FIG. 2 is a process flow diagram showing a method for analyzing geopolitical attributes over time via a digital computer, in accordance with one embodiment.

FIG. 3 is a flow diagram showing, by way of example, a process for calculating a market risk score.

FIG. 4 is a block diagram showing, by way of example, a risk scorecard.

FIG. 5 is a block diagram showing, by way of example, a risk score display.

FIG. 6 is a block diagram showing by way of example, a graph for historical risk tracking.

FIGS. 7A-B are block diagrams showing, by way of example, risk-return profiles.

FIG. 8 is a block diagram showing, by way of example, the risk-return profile of FIG. 7A with shifted risk-return values.

FIG. 9 is a block diagram showing, by way of example, a graph for profile shifting displayed via risk-return profiles.

FIG. 10 is a block diagram showing, by way of example, a graph for portfolio management using a risk-return profile.

### DETAILED DESCRIPTION

Currently, companies looking to expand into new market places, as medium- to long-term investments, spend large amounts of time and money for researching the viability of expansion and the actual expansion. The decision to expand is usually based on a point-in-time consideration of the market risk for expansion without considering any further changes in the market risk over time. However, at some point during the time period of approving the expansion and completing the expansion, the risk level may change drastically such that expansion is no longer feasible. Consistent determination of market risk over time allows companies to make accurately informed decisions about expansion and location desirability. Once an expansion has been completed, the market risk can be used to predict and improve performance in the expansion market.

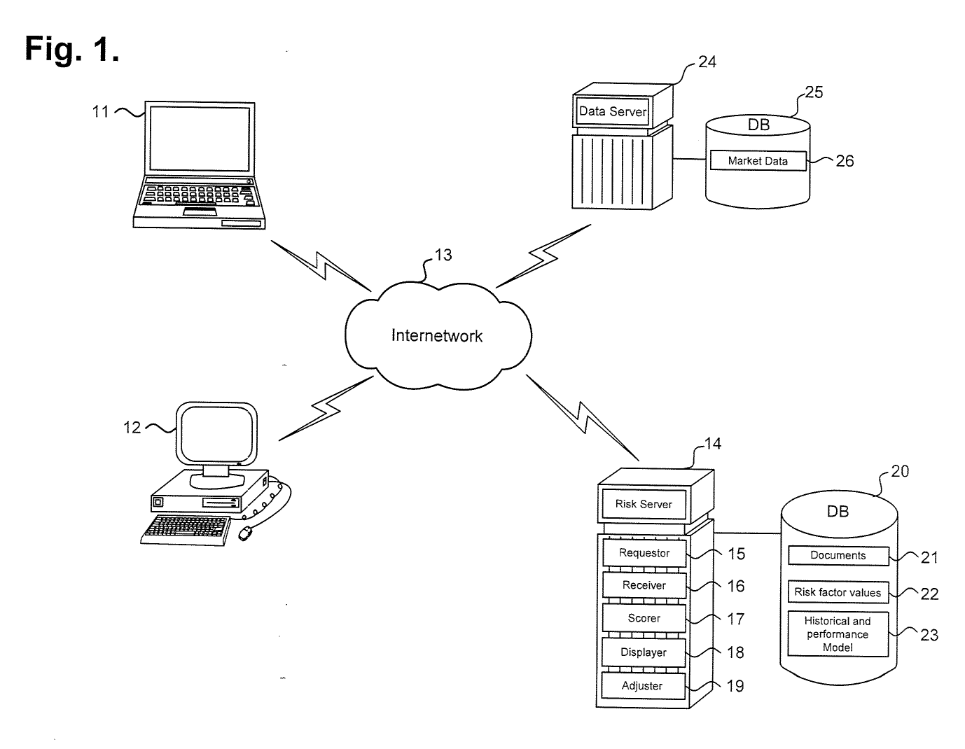

Dynamic analysis of market risk allow business managers to acquire a deep understanding of a market's operating condition over time, which can be used to make informed decisions regarding medium and long-term investments. FIG. 1 is a block diagram showing a system 10 for analyzing geopolitical attributes over time via a digital computer, in accordance with one embodiment. A user, such as a business owner or organization, can send a request for risk assessment of one or more markets via a desktop 12 or laptop 11 computer, as well as via a mobile computing device (not shown), such as a mobile phone or tablet. The markets can include those markets in which the user has established business sales or markets into which the user is thinking to expand. Together, the established markets and markets of interest form a portfolio of markets for the user. The request can be delivered to a risk server 14 via an internetwork 13, such as the Internet or a specialized network. The risk server includes a requestor 15, a receiver 16, a scorer 17, a displayer 18, and an adjuster 19, and is interconnected to a database 20. Upon receipt of the user's request for risk assessment, the requestor 15 can send a request for market data 26 for the markets identified by the user, to one or more data servers 24 interconnected via the internetwork 13. The data servers can each access the market data 26 from an interconnected database 25.

The market data 26 can include commercial risk information and geopolitical risk information, which is grouped into risk categories, including political, judicial and regulatory, economic, financial, social, environmental, and oil and gas services. Each geopolitical risk category includes discrete risk factors or attributes, including political stability, rule of law, and government control. Hereinafter, the terms “attributes” and “factors” are used interchangeably with the same intended meaning, unless otherwise indicated. Commercial and technical risk information is uniquely specific to an industry and include risk factors, such as labor, education, industrial relations, the competitive environment, currency stability, import-export regulations and infrastructure readiness. Other examples of risk categories and factors are possible. The market data can be collected from different resources, such as individuals, reports, and data requests, and can include qualitative or quantitative data, which is used to determine an amount of risk for a market.

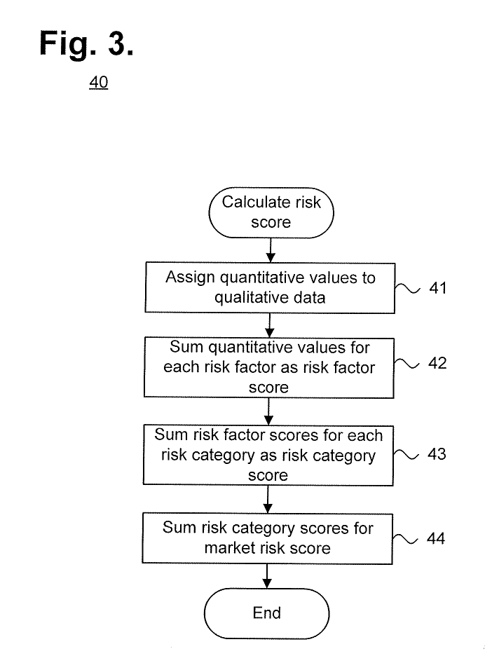

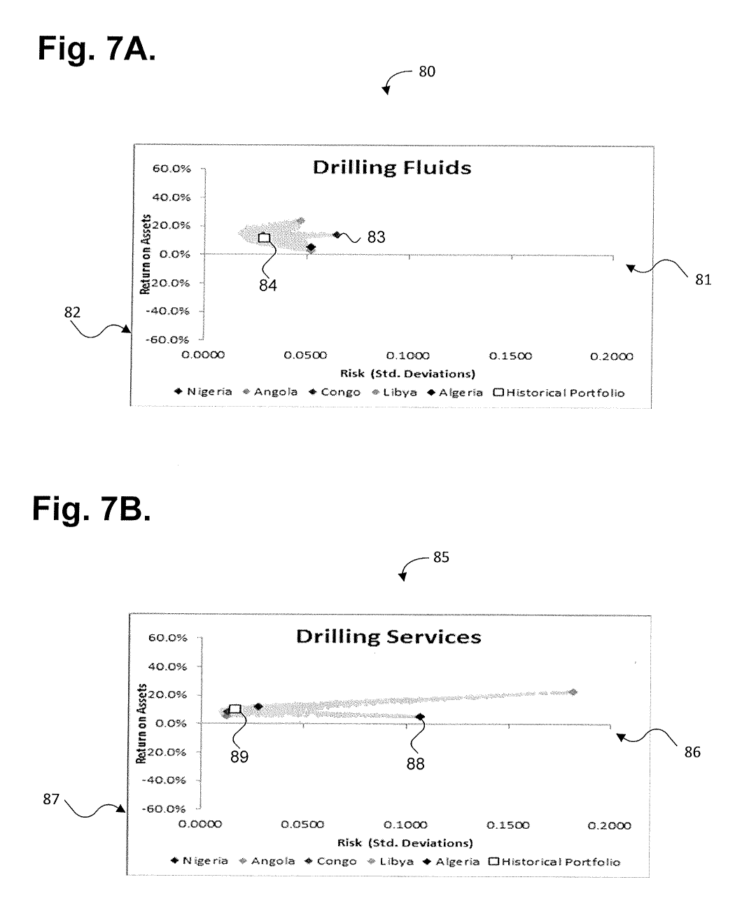

The data server 24 provides the market data 26 to the risk server 14 for storing in the database 20. The scorer 17 utilizes the market data to calculate risk scores, including risk factor scores for each risk factor, category risk scores for each geopolitical risk category and commercial risk category, and market risk scores for each market identified by the user. The risk scores can be stored in the database for future use. If the market data includes qualitative data, quantitative values are assigned for use in calculating the risk scores, as further described below with reference to FIG. 3. Subsequently, the displayer 18 displays one or more of the risk scores to the user. Over time, the collected risk scores can be used as historical data for each market to track risk levels and identify change in a particular market. Further, the adjuster 19 can use the historical risk scores to help improve an organization's performance through portfolio management and profile shifting, as further described below with reference to FIGS. 7-10.

The computing devices and servers can each include a central processing unit, random access memory (RAM), input/output ports, non-volatile secondary storage, such as a hard drive or CD ROM drive, network interfaces, peripheral devices, including user interfacing means, such as a keyboard and display, and one or more modules for carrying out the embodiments disclosed therein. Program code, including software programs, and data are loaded into the RAM for execution and processing by the CPU and results are generated for display, output, transmittal, or storage.

The modules can be implemented as a computer program or procedure written as source code in a conventional programming language and is presented for execution by the central processing unit as object or byte code. Alternatively, the modules could also be implemented in hardware, either as integrated circuitry or burned into read-only memory components, and each of the computing devices and server can act as a specialized computer. For instance, when the modules are implemented as hardware, that particular hardware is specialized to perform message prioritization and other computers cannot be used. Additionally, when the modules are burned into read-only memory components, the computing device or server storing the read-only memory becomes specialized to perform the message prioritization that other computers cannot. Other types of specialized computers are possible. Further, the management system can be limited to specific clients and specific hardware on which the management system is implemented, as well as limited by a subscription service to only subscribing clients. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

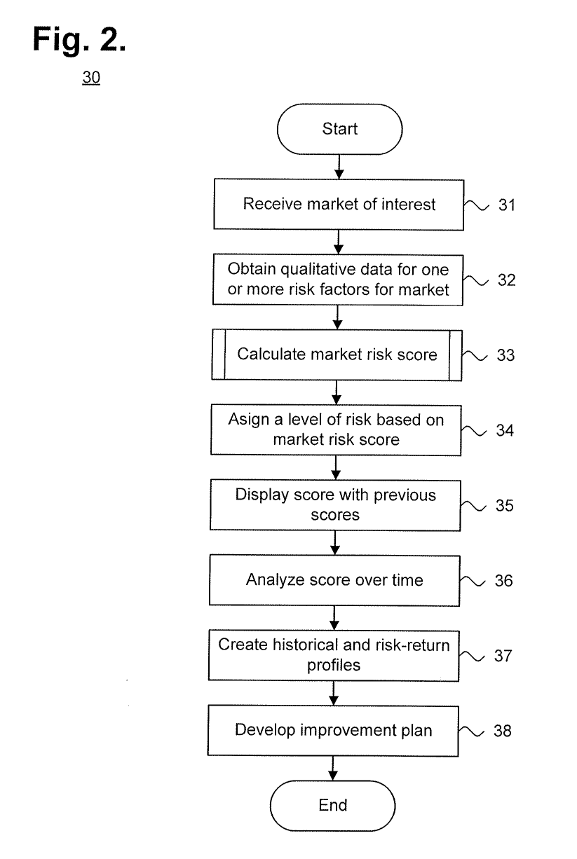

Dynamically analyzing risk in multiple markets can provide users with the information necessary to make well-informed decisions regarding new business ventures, such as market expansion, as well as maintaining business in existing markets. FIG. 2 is a flow diagram showing a method 30 for analyzing geopolitical attributes over time via a digital computer, in accordance with one embodiment. A user provides (block 31) a list of markets of interest, such as markets into which the user is considering to expand. Qualitative market data for one or more risk attributes or factors is obtained (block 32) for each of the markets of interest. As described above with reference to FIG. 1, the market data can include commercial and technical risk information, and geopolitical risk information, which is grouped into separate risk categories. The market data can be gathered for each market of interest via a questionnaire. Specifically, the questionnaire can be provided to consultants in each market of interest and can include questions, such as “has there been a change in political party?,” “are there any major internal conflicts?,” “are there any major international conflicts?,” and “has there been any change in currency over 10% within the past eight months?” Other questions are possible. One or more questions can be provided for each of a plurality of risk factors to be considered, and the questions can remain the same across different markets over time or can differ. Answers to the questions can be binary, including yes or no responses, and a predetermined score can be assigned to each of the binary values. In one embodiment, the completed questionnaires can be provided to the user to assist the user's understanding of critical risk factors that may be faced in different markets, as well as reasons for those risks.

A quantitative risk score is calculated (block 33) for each of the markets based on the qualitative answer scores and can be used to adjust outcomes at a project or portfolio level. In one example, a risk score for each market is calculated by converting the qualitative answers to quantitative values and summing those values. FIG. 3 is a flow diagram showing, by way of example, a process for calculating a market risk score for each market. The market risk score can be determined separately for geopolitical risk, and commercial and technical risk. Alternatively, the market risk score can include both the geopolitical risk, and commercial and technical risk.

As described above, the binary qualitative answers to the questionnaire can be associated with predetermined values. For example, with respect to the question, “has there been a change in political party?,” a yes response may receive a value of 0.08 while a no response can receive a value of 0.01, such that a higher value signifies more risk. Thus, to convert the qualitative responses to quantitative data, the predetermined value associated with the response is assigned (block 41) to each question. In a further example, weights are assigned to one or more of the questions based on an importance of that question to the quantitative market risk score and used to adjust the quantitative score assigned. Specifically, the weight is multiplied by the predetermined quantitative value for the answer received to obtain an adjusted quantitative score. The weights can change over time, as well as on a client-to-client basis or an industry basis. The weights can be determined automatically or by the user. However, other means for determining the quantitative answer scores are possible, including utilizing a constant. In this example, the constant can be multiplied by the weight and assigned quantitative score.

A risk factor score can then be calculated for each risk factor for the geopolitical risk categories and the commercial risk by summing (block 42) the predetermined values for those questions belonging to that risk factor. For instance, returning to the above example, the question “has there been a change in political party?” falls under the risk factor for governance structure within the political risk category. The question “has there been a change in leadership” also falls under the governance structure risk factor. However, the question “has there been a change in national security?” falls under a different risk factor for national security, which is also included in the political risk category. Thus, the predetermined response values for the questions regarding political party and leadership are summed to determine a risk score for the governance structure risk factor.

Next, a category risk score can be calculated for each geopolitical risk category and for commercial risk by summing (block 43) the risk factor scores associated with each risk category. Then, the category risk scores for each market can be summed (block 44) to determine the market risk score for each market in the user's portfolio. However, if commercial risk does not include multiple categories, the risk factor scores can be summed and used as the market risk score. In a further embodiment, a weight for one or more of the categories can be used, such that the risk score for a particular category is multiplied by a weight and then summed with the other category risk scores to determine the market risk score. In yet a further embodiment, a constant can be used in addition or in lieu of the weights. Other methods for calculating the risk factor scores, category risk scores, and market risk scores are possible, such as by determining a mean or median of the scores. The risk factor scores, category risk scores, and market risk scores can be calculated periodically over a period of time to provide a context for business decisions made in the past and to allow companies to improve business performance. In one example, the risk scores are calculated every quarter to track trends in each market.

Returning to the above discussion with respect to FIG. 2, once the market risk scores have been determined, a level of risk is determined (block 34) for each market. In one example, the risk levels can include three different levels with a threshold or a range assigned to each level in which to classify the market risk scores. For example, a low risk level can represent market risk scores from 0 to 35, a medium risk level covers market risk scores from 36 to 60, and a high risk level includes market risk scores of 61 to 80. Thus, a market with a market risk score of 44 falls under medium risk. Alternatively, using a two level risk structure, all markets with risk scores of 35 or below are considered low risk, while all markets with a market risk score of 36 or above are considered to be risky. Other numbers of and types of risk levels are possible.

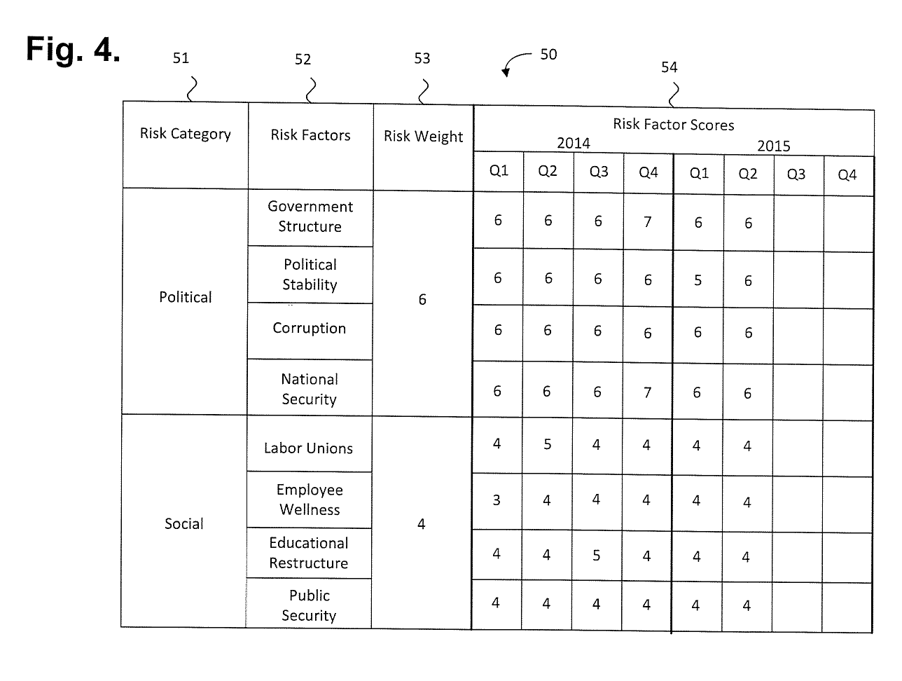

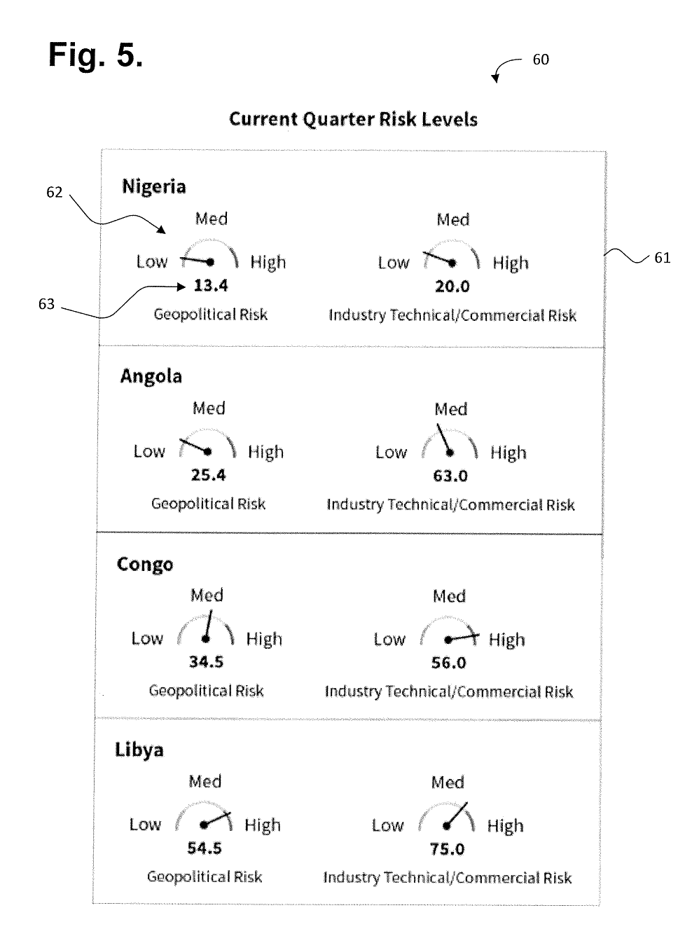

The risk levels can be displayed (block 35) for each market of interest along with the current market risk scores and optionally, past market risk scores. In one embodiment, a visual representation of the risk level can include a speedometer view that maps the risk for each market based on three levels of risk: low, medium, and high, as further described below with reference to FIG. 5. Each level of risk can be associated with a location desirability, which indicates how desirable that market is for expansion. For instance, those markets that are desirable have a low level of risk, while those markets that are undesirable or less desirable have a higher level of risk. Other visuals and levels of risk are possible. The market risk scores, which are collected over time at various periods, can be analyzed (block 36) to create (block 37) historical and risk-return profiles for maximizing a portfolio's performance by developing (block 38) an improvement plan for the performance. The historical and risk-return profiles, as well as portfolio improvement, are further described below with reference to FIGS. 4 and 6-10.

The market risk analysis can be offered based on a subscription and subscribers can receive updated risk scores at predetermined times, such as annually, quarterly, or monthly, as well as at other times, such as when requested. The risk scores can be stored and used by a company to determine or review why decisions were made and the conditions that existed at the time the decision was made. Further, once one or more of the markets has been selected for expansion, actual performance data in those markets can be recorded and provided with the current risk scores.

The risk factor scores and category risk scores can be recorded and stored as a risk scorecard to provide a historical record of the risk analysis for each market. FIG. 4 is a block diagram showing, by way of example, a risk scorecard 50. The risk scorecard 50 can record and store data for later use, such as historical reports. Specifically, the risk scorecard 50 can include risk categories 51 for geopolitical risk and commercial risk. The risk categories can each be associated with one or more risk factors 52. As described above, the risk categories for geopolitical risk can include political, judicial and regulatory, economic, financial, social, environmental, and oil and gas services. In one embodiment, commercial risk does not include categories, only risk factors.

As shown on the risk scorecard, the risk factors are each associated with at least one score 54 calculated at a predetermined time, such as every quarter. The risk factors can include, for example, government structure, political stability, corruption, and national security for the political category, while the risk factors for the social risk category can include labor unions, employee wellness, educational restructure, and public security. Other risk categories and risk factors are possible.

A category risk score or weight 53 can be determined for each risk category. Each category risk score can be based on risk factor scores 54 for each of the risk factors in that category and can be calculated as a summation of the risk factor scores for the risk factors. Alternatively, the category risk score can be calculated as an average of the risk factor scores for the associated risk factors of that category or as a summation using weights associated with one or more of the risk factors. The category risk weights can be updated annually based on the quarterly risk scores for the risk factors associated with that category for the previous year. Other times for calculating the risk factor scores and updating the category risk scores are possible.

In a further embodiment, the commercial risk factor scores and commercial market risk scores can be included on the same card as the geopolitical risk scores or on a different scorecard.

Once determined, the market risk scores for geopolitical risk and commercial risk can be displayed. FIG. 5 is a block diagram showing, by way of example, a market risk score display 60. Market risk scores for geopolitical risk and commercial risk can each be displayed for each market of interest 61 via a speedometer view 62, which can include a range of risk values mapped along a half circle, starting with no or little risk on a left side of the half circle and the highest risk on a right side. A pointer is placed along the half circle to represent the risk calculated for each market and the risk level associated with the calculated risk, as described above with respect to FIG. 3. The market risk score 63 can then be placed below the speedometer view for each of the geopolitical risk and commercial risk.

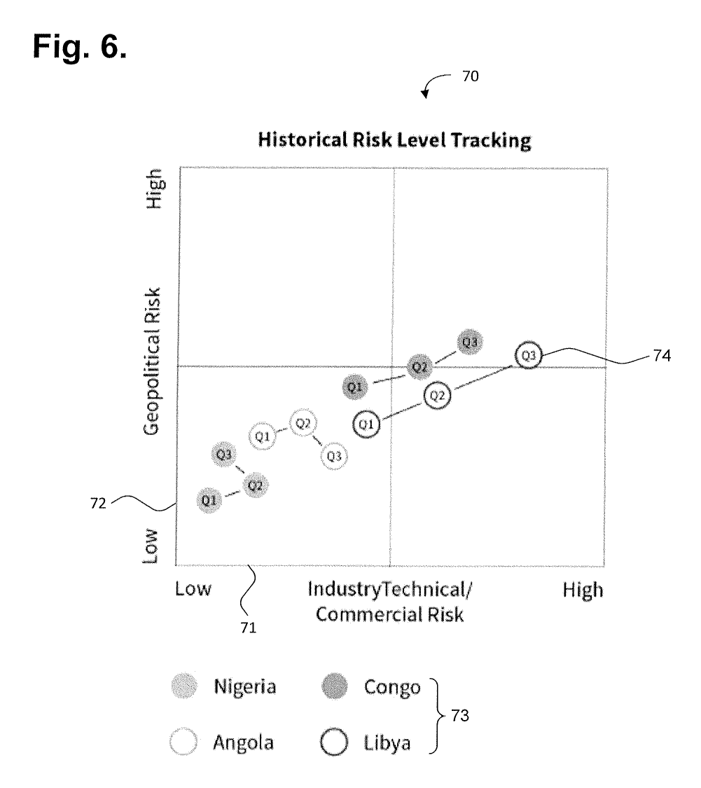

In addition to displays of current risk scores, historical risk scores can also be displayed to provide an overall view of a risk climate for one or more markets. FIG. 6 is a block diagram showing, by way of example, a graph 70 for historical risk tracking. The graph 70 includes market risk scores for commercial risk along an x-axis 71 and market risk scores for geopolitical risk along a y-axis 72 of the graph. The market risk scores for each market are displayed over a predetermined amount of time via nodes 74. Specifically, for each determined time period at which the market risk scores are calculated, a node is placed for each market based on coordinates determined using the value of the market risk for commercial risk along the x-axis and the value of the market risk for geopolitical risk along the y-axis.

In the current example, the graph 70 represents a portfolio of markets for an oil and gas industry services corporation and displays market risk scores for four different markets over three quarters, during which the market risk scores were calculated at the end of each quarter. Each of the different markets can be identified by an assigned color or pattern of the nodes, which can be provided in a legend 73 of the markets. For two of the countries, Congo and Libya, the risk profiles changed rapidly, which is evidenced by the increase in market risk scores for both geopolitical risk and commercial risk over the time period of three quarters. Reasons for the rapid change, especially the increase in risk, can be due to growing political instability and currency devaluation, as well as many other factors. While, during the same time, the other two countries of Nigeria and Angola, demonstrated more stability on geopolitical, as well as industrial risk frontiers, as shown by the clustering of nodes for the market risk scores in the low risk range.

Further, mapping of the historical market risk scores with respect to values for a historical return on assets in established markets can help users to evaluate their product lines across markets. FIGS. 7A-B are block diagrams showing, by way of example, risk-return profiles. Risk-return profiles plot a historical return on assets against a risk of those returns, based on a standard deviation of the returns over a period of time for each market for which a particular product line operates. The return can include a return on assets, operating income, return on equity, and return on investment, as well as other measures of return. The risk-return profiles assist users in determining whether they are being adequately compensated for the risk they are incurring for that product line.

The return data and risk data for plotting in the risk-return profile can be collected over a period of time. In one embodiment, a time period of eight quarters is used to collect the data; however, other periods of time are possible. To generate a risk-return profile, a standard deviation of risk, such as the market risk scores, for each market is determined and plotted against an average return over the eight quarters as a historical market value. Further, a historical average of the plotted values for all the markets is determined and plotted within the risk-return profile. Alternatively, the risk-return performance can be plotted using a weighted portfolio of markets for the product line, as well as simulated weights. The simulated weights can be determined using Monte Carlo simulations, as well as other methods for generating simulations.

The risk-return profiles allow a user to evaluate a particular product line's local performance optimization, as well as the optimization of the product line across the portfolio of markets. Based on the optimization evaluation, a user can adjust a level of activity in various markets to increase optimization of the portfolio. The risk-return profile 80 of FIG. 7A includes standard deviations for risk along an x-axis 81 and return values along a y-axis 82. Values are displayed for drilling fluids provided in Nigeria, Angola, Congo, Libya, and Algeria, which are each represented by an icon 83 within the profile, such as a diamond. The historical average 84 of all the listed countries can be represented by a square. However, other representations of the individual country values and historical average are possible. In the profile, Congo shows the highest variation of risk over time with a medium return, while Angola shows a lower variation of risk over time with a higher return. Both the plotted values for Congo and Angola are fairly close to the historical average.

The risk-return profile 85 of FIG. 7B maps return values versus risk for drilling services provided in Nigeria, Angola, Congo, Libya, and Algeria. The standard deviation of risk values is mapped along an x-axis 86, while the return values are mapped along a y-axis 87. The risk-return value for each country, which is calculated over time, is displayed via an icon, such as a diamond 88. The historical average 89 of all the listed countries can be represented by a square. However, other representations of the individual country values and historical average are possible. In the profile, the risk variability for Congo is less than for drilling fluids, while the return is similar and for Angola, the variability of risk is much higher for drilling services than drilling fluids and the return is similar. Both the plotted values for Congo and Angola are fairly far from the historical average.

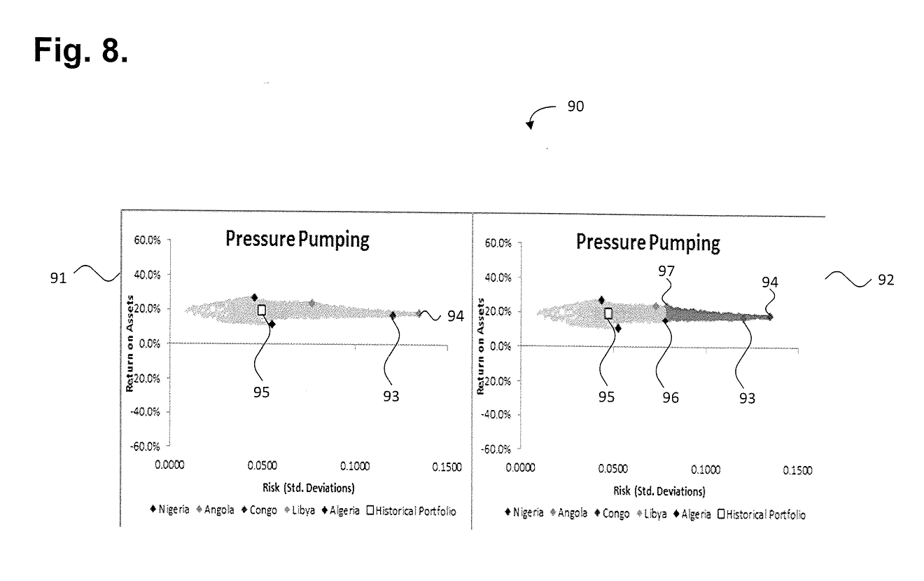

Ideally, the individual historical market values should be close to the historical average. One or more of the markets can be shifted vertically or horizontally to improve performance and move closer to the historical average. FIG. 8 is a block diagram showing, by way of example, a graph 90 of a first risk-return profile 91 and a shifted risk-return profile 92 based on the first risk return profile. In the first risk return profile, the risk-return values for Congo 93 and Angola 94 are the furthest from the historical average 95. As described above, the risk-return values for each country should ideally be close to the historical average. To bring the risk-return values for Congo and Angola closer to the historical average 95, performance improvement initiatives can be applied to business in those countries. Specifically, to move the values vertically, initiatives, such as cost savings initiatives, including price increases, or local asset efficiency programs can be implemented, while a horizontal shift includes smoothing demand peaks and valleys for products or services, which can reduce period-to-period variations for the return and risk factors. Other programs for vertical and horizontal shifting are possible.

Upon implementation of the performance improvement initiatives, the risk-return values for each mark are determined at predetermined time periods and if the initiatives are successful, shifting of the risk-return values for one or more markets will appear. The shifted risk-return profile 92 shows that the newly calculated risk-return values for Congo 96 and Angola 97 are now closer to the historical average 95 based on implementation of the performance improvement initiatives.

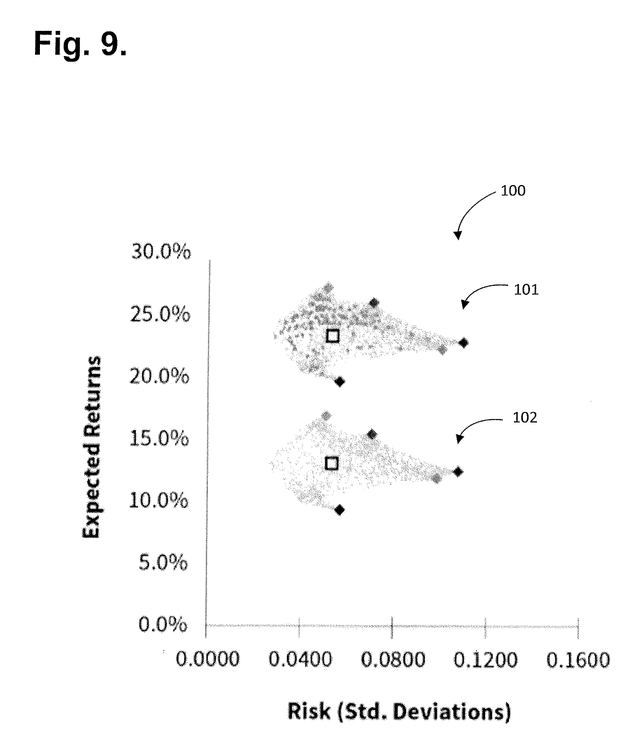

In a further embodiment, a global shifting of all the markets in the portfolio can occur to increase return values. FIG. 9 is a block diagram showing, by way of example, the risk-return profile of FIG. 7A with shifted risk-return values. To increase the performance of a portfolio, equal improvement opportunities are implemented across all markets in the portfolio to result in vertical shifting of the entire risk-return profile without changing a shape of the profile. For instance, market performance can be shifted vertically by implementing price increases or cost savings initiatives. For instance, the risk-return profile 92 of FIG. 7A is displayed. Based on improvement initiatives implemented across all markets in the portfolio, the risk-return profile 91 shifted vertically based on new risk-return values calculated for the markets, which include increased returns. In a further embodiment, the shifting can occur horizontally. For example, a shift of risk can occur by working with customers to smooth demand peaks and valleys for products or services, or by altering an underlying cost structure that supports the market.

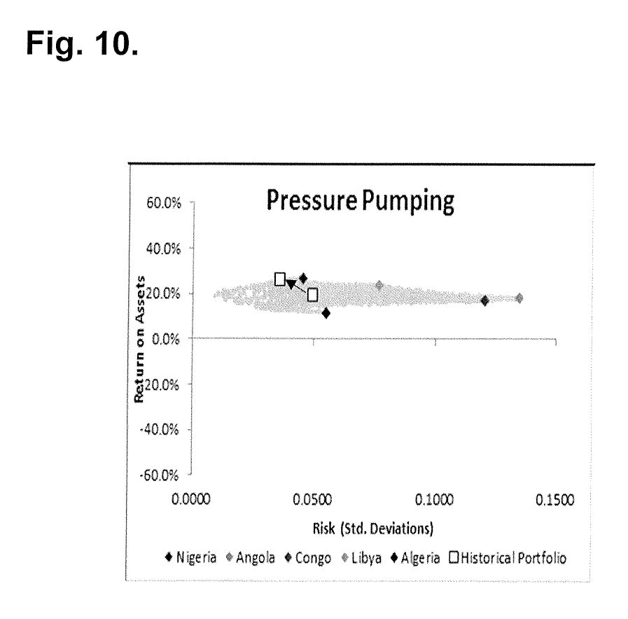

The risk-return profiles can also be used to help identify a need to improve a user's performance through portfolio management. Portfolio management includes improving a weight of activity performed in specific markets to maximize the market portfolio's risk-return metric. FIG. 10 is a block diagram showing, by way of example, a graph for portfolio management using a risk-return profile.

While the invention has been particularly shown and described as referenced to the embodiments thereof, those skilled in the art will understand that the foregoing and other changes in form and detail may be made therein without departing from the spirit and scope of the invention.

What is claimed is:

1. A system for analyzing geopolitical attributes over time via a digital computer, comprising:
a computing device to generate a request for analysis of one or more attributes;
one or more data servers to collect and store qualitative data for attributes for one or more markets; and
a server comprising a central processing unit, an input port to receive the request from the computing device and the data from the data servers at predefined times, memory to store the received data from the data servers, and an output port, wherein the central processing unit is configured to:
identify one or more markets of interest;
analyze the qualitative data for the attributes of each of the markets of interest;
determine for each market of interest, a score based on the qualitative data for that market;
classify for each score, of each market, a desirability of a location associated with that market; and
display the scores and the location desirability for each of the markets at each of the predetermined times.

2. A system according to claim 1, wherein the central processing unit is further configured to:
receive the qualitative data as binary responses; and
calculate the score based on the binary responses by associating quantitative values to each possible binary response for each attribute, receiving one of the binary responses for each attribute for each market, and totaling for each market, the quantitative values associated with each of the received binary responses as the score for that market.

3. A system according to claim 1, wherein the central processing unit is further configured to:
assign a weight to each of the attributes; and
apply the weight for each attribute to the corresponding scores for that attribute.

4. A system according to claim 1, wherein the central processing unit is further configured to:
build a risk return profile for each of the markets, wherein the risk return profile plots a historical return on assets against a risk of return.

5. A system according to claim 1, wherein the central processing unit is further configured to:
graph the risk return profile by determining a standard deviation of risk for each market at each predetermined time and plotting for each market, a value for the standard deviation of risk against an average return on assets for each predetermined time period.

6. A system according to claim 5, wherein the central processing unit is further configured to:
determine for each market, a historical average of values for the standard deviation of risk and the average return on assets; and
plot the historical average within the graphed risk return profile.

7. A system according to claim 6, wherein the central processing unit is further configured to:
compare the plotted market values with the historical average; and
identify those markets that are underperforming.

8. A system according to claim 7, wherein the central processing unit is further configured to:
provide a recommendation for improvement of market performance based on the comparison of the plotted market values with the historical average.

9. A system according to claim 1, wherein the central processing unit is further configured to:
develop a plan based on the scores and the location desirability for one or more of the markets.

10. A system according to claim 1, wherein the location desirability is mapped for each market based on three levels.

11. A method for analyzing geopolitical attributes over time via a digital computer, comprising:
identifying markets of interest;
receiving qualitative data for one or more attributes for each of the markets of interest at predefined time periods;
determining for each market of interest, a score based on the qualitative data for the attributes for that market;
classifying for each score, of each market, a location desirability; and
displaying the scores and the location desirability for each of the markets at each of the predetermined times.

12. A method according to claim 11, further comprising:
receiving the qualitative data as binary responses; and
calculating the score based on the binary responses, comprising:
associating quantitative values to each possible binary response for each attribute;
receiving one of the binary responses for each attribute for each market; and
totaling for each market, the quantitative values associated with each of the received binary responses as the score for that market.

13. A method according to claim 11, further comprising:
assigning a weight to each of the attributes; and
applying the weight for each attribute to the corresponding scores for that attribute.

14. A method according to claim 11, further comprising:
building a risk return profile for each of the markets, wherein the risk return profile plots a historical return on assets against a risk of return.

15. A method according to claim 11, further comprising:
graphing the risk return profile, comprising:
determining a standard deviation of risk for each market at each predetermined time;
plotting for each market, a value for the standard deviation of risk against an average return on assets for each predetermined time period.

16. A method according to claim 15, further comprising:
determining for each market, a historical average of values for the standard deviation of risk and the average return on assets; and
plotting the historical average within the graphed risk return profile.

17. A method according to claim 16, further comprising:
comparing the plotted market values with the historical average; and
identifying those markets that are underperforming.

18. A method according to claim 17, further comprising:
providing a recommendation for improvement of market performance based on the comparison of the plotted market values with the historical average.

19. A method according to claim 11, further comprising:
developing a plan based on the scores and the location desirability for one or more of the markets.

20. A method according to claim 11, wherein the location desirability is mapped for each market based on three levels.
